(19) United States
(12) Patent Application Publication
(10) Pub. No.: US 2013/0034779 A1
(43) Pub. Date: Feb. 7, 2013

(54) ELECTROLYTE FOR RECHARGEABLE LITHIUM BATTERY, AND RECHARGEABLE LITHIUM BATTERY INCLUDING THE SAME

(71) Applicants: Mi-Hyeun Oh, Yongin-si (KR); Ho-Seok Yang, Yongin-si (KR); Man-Seok Han, Yongin-si (KR); Dai-In Park, Yongin-si (KR); Jin-Hyunk Lim, Yongin-si (KR)

(72) Inventors: Mi-Hyeun Oh, Yongin-si (KR); Ho-Seok Yang, Yongin-si (KR); Man-Seok Han, Yongin-si (KR); Dai-In Park, Yongin-si (KR); Jin-Hyunk Lim, Yongin-si (KR)

(73) Assignee: Samsung SDI Co., Ltd., Yongin-si (KR)

(21) Appl. No.: 13/353,121

(22) Filed: Jan. 18, 2012

(30) Foreign Application Priority Data
Aug. 2, 2011 (KR) 10-2011-0077106

(51) Int. Cl. H01M 10/02

(52) U.S. Cl. 429/332; 429/338

(57) ABSTRACT

In one aspect, an electrolyte for a rechargeable lithium battery that includes a lithium salt, an organic solvent including ethylene carbonate and an additive including diphenyl carbonate, and a rechargeable lithium battery including the same are provided.

### CROSS-REFERENCE TO RELATED APPLICATIONS

This application claims priority to and the benefit of Korean Patent Application No. 10-2011-0077106 filed on Aug. 2, 2011 in the Korean Intellectual Property Office, the disclosure of which is incorporated herein in its entirety by reference.

### BACKGROUND

1. Field

This disclosure relates to an electrolyte for a rechargeable lithium battery and a rechargeable lithium battery including the same.

2. Description of the Related Technology

Lithium rechargeable batteries using an organic electrolyte have twice or more the discharge voltage than a conventional battery using an alkali aqueous solution, and accordingly have high energy density. This rechargeable lithium battery operates by injecting an electrolyte into a battery cell having a positive electrode having a positive active material that can intercalate and deintercalate lithium, and a negative electrode including a negative active material that can intercalate and deintercalate lithium. The electrolyte is prepared by dissolving a lithium salt in an organic solvent. Methods of increasing a usage voltage band to a high voltage have can increase the capacity of rechargeable lithium battery. However, the cycle-life is rapidly deteriorated when increasing a usage voltage band to a high voltage under these conditions. For example, the low temperature cycle-life may be seriously degraded due to increasing the resistance at a low temperature.

### SUMMARY

One aspect of this disclosure provides an electrolyte for a rechargeable lithium battery having an excellent cycle-life characteristic in a high voltage and at a low temperature.

Another aspect of this disclosure provides a rechargeable lithium battery including the electrolyte.

According to one embodiment, provided is an electrolyte for a rechargeable lithium battery that includes about 1.3 M to about 2.0 M of a lithium salt; an organic solvent including ethylene carbonate; and an additive including diphenyl carbonate, wherein the ethylene carbonate is included in about 20 volume % to about 40 volume % based on the total amount of the organic solvent, and the diphenyl carbonate is included in about 0.5 parts to about 10 parts by weight based on the total 100 parts by weight of the organic solvent.

In some embodiments, the ethylene carbonate may be included in about 20 volume % to about 35 volume % based on the total amount of the organic solvent.

In some embodiments, the diphenyl carbonate may be included in about 0.5 parts to about 5 parts by weight based on the total 100 parts by weight of the organic solvent.

In some embodiments, the organic solvent may further include ethylmethyl carbonate and dimethyl carbonate, and ethylmethyl carbonate and the dimethyl carbonate are included in about 10 volume % to 60 volume % and about 20 volume % to 70 volume %, respectively, based on the total amount of the organic solvent.

According to another embodiment, provided is a rechargeable lithium battery that includes a positive electrode, a negative electrode; and an electrolyte including about 1.3 M to about 2.0 M of lithium salt, an organic solvent including ethylene carbonate, and an additive including diphenyl carbonate, wherein the ethylene carbonate is included in about 20 volume % to 40 volume % based on the total amount of the organic solvent, and the diphenyl carbonate is included in about 0.5 parts to 10 parts by weight based on total 100 parts by weight of the organic solvent.

In some embodiments, the ethylene carbonate may be included in about 20 volume % to 35 volume % based on the total amount of the organic solvent.

In some embodiments, the diphenyl carbonate may be included in about 0.5 parts to 5 parts by weight based on the total 100 parts by weight of the organic solvent.

In some embodiments, the organic solvent may further include ethylmethyl carbonate and dimethyl carbonate, and the ethylmethyl carbonate and the dimethyl carbonate may be included in about 20 volume % to 80 volume % and about 20 volume % to 80 volume %, respectively, based on the total amount of organic solvent.

In some embodiments, the rechargeable lithium battery may have a charge voltage of about 4.3 V or more.

Hereinafter, further embodiments will be described in the detailed description.

Some embodiments provide a rechargeable lithium battery having an excellent cycle-life at a high voltage and at a low temperature.

### BRIEF DESCRIPTION OF THE DRAWING

FIG. 1 is a schematic view showing a rechargeable lithium battery according to one embodiment.

### DETAILED DESCRIPTION

Exemplary embodiments will hereinafter be described in detail. However, these embodiments are only exemplary, and this disclosure is not limited thereto.

The electrolyte for a rechargeable lithium battery according to one embodiment includes a lithium salt, an organic solvent and an additive.

The lithium salt supplies lithium ions in the battery, and operates a basic operation of a rechargeable lithium battery and improves lithium ion transportation between positive and negative electrodes.

In some embodiments, the lithium salt may include LiPF₆, LiBF₄, LiSbF₆, LiAsF₆, LiN(SO₃C₂F₅)₂, LiC₄F₉SO₃, LiClO₄, LiAlO₂, LiAlCl₄, LiN(SO₂CₓF₂ₓ₊₁)(SO₂C_{y}F_{2y+1}) where x and y are natural numbers, LiCl, LiI, LiB(C₂O₄)₂ (lithium bis(oxalato) borate, LiBOB), or a combination thereof, but is not limited thereto.

In some embodiments, the concentration of the lithium salt may range from about 1.3 M to about 2.0 M, and specifically about 1.3 M to about 1.5 M. In some embodiment, the lithium salt can be included at the concentration range of from about 1.3 M to about 2.0 M providing increased conductivity and excellent cycle-life at a high voltage.

The organic solvent acts as a medium for transmitting ions taking part in the electrochemical reaction of the battery.

In some embodiments, the organic solvent may include ethylene carbonate (EC).

Ethylene carbonate has a high dielectric constant and can dissociate the lithium salt.

In some embodiments, the ethylene carbonate may be included in about 20 volume % to 40 volume %, for example, about 20 volume % to 35 volume %, or about 20 volume % to 30 volume % based on the total amount of the organic solvent. Ethylene carbonate included in about 20 volume % to 40 volume %, may have a high dielectric constant to increase the dissociation property for a lithium salt and may provide an excellent battery cycle-life characteristic at a high voltage.

In some embodiments, the ethylene carbonate may be used along with a cyclic carbonate compound of propylene carbonate (PC), butylene carbonate (BC), fluoroethylene carbonate (FEC), vinylethylene carbonate (VEC), or a combination thereof.

In some embodiments, the ethylene carbonate may be used along with a linear carbonate compound having a low viscosity.

In some embodiments, the linear carbonate compound may include diethyl carbonate (DEC), ethylmethyl carbonate (EMC), dimethyl carbonate (DMC), dipropyl carbonate (DPC), methylpropyl carbonate (MPC), ethylpropyl carbonate (EPC), methylethyl carbonate (MEC), or a combination thereof. In one embodiment, ethylmethyl carbonate, dimethyl carbonate, or a combination thereof may be desirable.

In some embodiments, the ethylmethyl carbonate may be included in about 10 volume % to 60 volume %, for example, about 20 volume % to 40 volume % based on the total amount of the organic solvent. In addition, the dimethyl carbonate may be included in about 20 volume % to 70 volume %, for example, about 40 volume % to 60 volume % based on the total amount of the organic solvent. In some embodiments, the ethylmethyl carbonate and the dimethyl carbonate may improve cycle-life characteristics of a battery at a low temperature.

In some embodiments, the ethylene carbonate may be used along with an ester-based compound, an ether-based compound, a ketone-based compound, an alcohol-based compound, an aprotic solvent, or a combination thereof.

In some embodiments, the ester-based compound may include methylacetate, ethylacetate, n-propylacetate, dimethylacetate, methylpropionate, ethylpropionate, γ-butyrolactone, decanolide, valerolactone, mevalonolactone, caprolactone, and the like. The ether-based compound may include dibutylether, tetraglyme, diglyme, dimethoxyethane, 2-methyltetrahydrofuran, tetrahydrofuran, and the like, and the ketone-based compound may include cyclohexanone, and the like. The alcohol-based compound may include ethanol, isopropyl alcohol, and the like.

In some embodiments, the additive may include diphenyl carbonate.

In some embodiments, the diphenyl carbonate can be added into the electrolyte. In some embodiments, the diphenyl carbonate may improve the cycle-life characteristic at a low temperature as well as the cycle-life characteristic in a high voltage.

In some embodiments, the diphenyl carbonate may be included in about 0.5 parts to 10 parts by weight, for example, about 0.5 parts to 5 parts by weight or about 0.5 parts to 3 parts by weight based on the total 100 parts by weight of the organic solvent. In some embodiments, the diphenyl carbonate included in about 0.5 parts to 10 parts by weight may prevent the deterioration of ionic conductivity due to using ethylene carbonate having a high viscosity. In some embodiments, the diphenyl carbonate included in about 0.5 parts to 10 parts by weight may improve the cycle-life characteristic at a low temperature while maintaining the excellent cycle-life characteristics at a high voltage.

As described above, ethylene carbonate, and diphenyl carbonate included in an electrolyte in an appropriate amount may provide a rechargeable lithium battery with excellent cycle-life characteristics at a high voltage and a low temperature.

In some embodiments, the rechargeable lithium battery may have a charge voltage of about 4.3V or more, for example, a charge voltage of about 4.3 to 4.4 V.

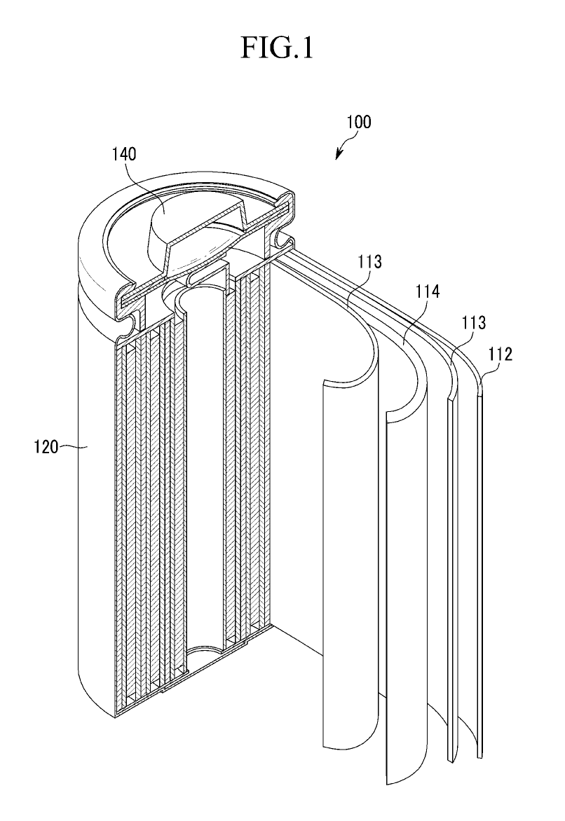

Hereafter, a rechargeable lithium battery including the electrolyte is described with reference to FIG. 1.

FIG. 1 is a schematic view of a representative structure of a rechargeable lithium battery according to one embodiment.

Referring to FIG. 1, the rechargeable lithium battery 100 includes an electrode assembly including a positive electrode 114, a negative electrode 112 facing the positive electrode 114, a separator 113 between the positive electrode 114 and negative electrode 112, and an electrolyte (not shown) impregnating the positive electrode 114, negative electrode 112, and separator 113, a battery case 20 housing the electrode assembly, and a sealing member 140 sealing the battery case.

In some embodiments, the positive electrode 114 may include a positive current collector and a positive active material layer on the positive current collector. In some embodiments, the positive active material layer may include a positive active material, a binder, and selectively, a conductive material.

In some embodiments, the positive current collector may be Al (aluminum) but is not limited thereto.

The positive active material includes lithiated intercalation compounds that reversibly intercalate and deintercalate lithium ions In some embodiments, the positive active material may include a composite oxide including at least one selected from the group consisting of cobalt, manganese, and nickel, as well as lithium. In some embodiments, the positive active material may be used the following lithium-containing compounds, but is not limited thereto:

LiₐA_{1-b}B_{b}D₂ (0.90≦a≦1.8, and 0≦b≦0.5); LiₐE_{1-b}B_{b}I_{2-c}D_{c} (0.90≦a≦1.8, 0≦b≦0.5, and 0≦c≦0.05); LiE_{2-b}B_{b}O_{4-c}D_{c} (0≦b≦0.5, and 0≦c≦0.05); LiₐNi_{1-b-c}Co_{b}B_{c}D_{α} (0.90≦a≦1.8, 0≦b≦0.5, 0≦c≦0.05, and 0<α≦2); LiₐNi_{1-b-c}Co_{b}B_{c}O_{2-α}F_{α} (0.90≦a≦1.8, 0≦b≦0.5, 0≦c≦0.05, and 0<α<2); LiₐNi_{1-b-c}Co_{b}B_{c}O_{2-α}F₂ (0.90≦a≦1.8, 0≦b≦0.5, 0≦c≦0.05, and 0<α<2); LiₐNi_{1-bc}Mn_{b}B_{c}D_{α} (0.90≦a≦1.8, 0≦b≦0.5, 0≦c≦0.05, and 0<α<2); LiₐNi_{1-b-c}Mn_{b}B_{c}O_{2-α}F_{α} (0.90≦a≦1.8, 0≦b≦0.5, 0≦c≦0.05, and 0<α<2); LiₐNi_{1-b-c}Mn_{b}B_{c}O_{2-α}F₂ (0.90≦a≦1.8, 0≦b≦0.5, 0≦c≦0.05, and 0<α<2); LiₐNi_{b}E_{c}G_{d}O₂ (0.90≦a≦1.8, 0≦b≦0.9, 0≦c≦0.5, and 0.001≦d≦0.1); LiₐNi_{b}Co_{c}Mn_{d}GeO₂ (0.90≦a≦1.8, 0≦b≦0.9, 0≦c≦0.5, 0≦d≦0.5, and 0.001≦e≦0.1); LiₐNiG_{b}O₂ (0.90≦a≦1.8, and 0.001≦b≦0.1); LiₐCoG_{b}O₂ (0.90≦a≦1.8, and 0.001≦b≦0.1); LiₐMnG_{b}O₂ (0.90≦a≦1.8, and 0.001≦b≦0.1); LiₐMn₂G_{b}O₄ (0.90≦a≦1.8, and 0.001≦b≦0.1); QO₂; QS₂; LiQS₂; V₂O₅; LiV₂O₅; LiIO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulas, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

In some embodiments, the positive active material may include the positive active material with the coating layer, or a compound of the active material and the active material coated with the coating layer. In some embodiments, the coating layer may include at least one coating element compound selected from the group consisting of an oxide of a coating element, and a hydroxide of the coating element, an oxyhydroxide of the coating element, an oxycarbonate of the coating element, and a hydroxycarbonate of the coating element. In some embodiments, the compound for the coating layer may be either amorphous or crystalline. In some embodiments, the coating element included in the coating layer may be Mg, Al, Co, K, Na, Ca, Si, Ti, V, Sn, Ge, Ga, B, As, Zr, or a mixture thereof. In some embodiments, the coating process may include any conventional processes as long as it does not causes any side effects on the properties of the positive active material (e.g., spray coating, immersing), which is well known to persons having ordinary skill in this art, so a detailed description thereof is omitted.

The binder improves binding properties of the positive active material particles to each other and to a current collector. Examples of the binder include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves electrical conductivity of a negative electrode. Any electrically conductive material may be used as a conductive agent unless it causes a chemical change. Examples of the conductive material include natural graphite, artificial graphite, carbon black, acetylene black, ketjen black, a carbon fiber, a metal powder or a metal fiber of copper, nickel, aluminum, silver, and the like, and a polyphenylene derivative, which may be used singularly or as a mixture thereof.

The negative electrode 112 includes a negative current collector and a negative active material layer disposed thereon.

In some embodiments, the negative current collector may include a copper foil, a nickel foil, a stainless steel foil, a titanium foil, a nickel foam, a copper foam, a polymer substrate coated with a conductive metal, and combinations thereof, but is not limited thereto.

In some embodiments, the negative active material layer may include a negative active material, a binder, and optionally a conductive material.

In some embodiments, the negative active material can include a material that reversibly intercalates/deintercalates lithium ions, a lithium metal, a lithium metal alloy, a material being capable of doping/dedoping lithium, or a transition metal oxide.

In some embodiments, the material that can reversibly intercalate/deintercalate lithium ions can include a carbon material. In some embodiments, the carbon material may be any generally-used carbon-based negative active material in a lithium ion rechargeable battery. Examples of the carbon material include crystalline carbon, amorphous carbon, and mixtures thereof. In some embodiments, the crystalline carbon may be non-shaped, or sheet, flake, spherical, or fiber shaped natural graphite or artificial graphite. In some embodiments, the amorphous carbon may be a soft carbon, a hard carbon, a mesophase pitch carbonization product, fired coke, and the like.

Examples of the lithium metal alloy include lithium and a metal selected from Na, K, Rb, Cs, Fr, Be, Mg, Ca, Sr, Si, Sb, Pb, In, Zn, Ba, Ra, Ge, Al, and Sn.

In some embodiments, the material being capable of doping/dedoping lithium may include Si, SiOₓ (0<x<2), a Si—C composite, a Si—Y alloy (wherein Y is selected from an alkali metal, an alkaline-earth metal, Group 13 to Group 16 elements, a transition element, a rare earth element, and a combination thereof, and not Si), Sn, SnO₂, a Sn—C composite, a Sn—Y alloy (wherein Y is selected from an alkali metal, an alkaline-earth metal, Group 13 to Group 16 elements, a transition element, a rare earth element, and a combination thereof, and not Sn), and the like. At least one of these materials may be mixed with SiO₂. In some embodiments, the component Y may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

Examples of the transition metal oxide include vanadium oxide, lithium vanadium oxide, and the like.

The binder improves binding properties of negative active material particles with one another and with a current collector. Examples of the binder include polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

In some embodiments, the conductive material can be included to improve electrode conductivity. Any electrically conductive material may be used as a conductive material unless it causes a chemical change. Examples of the conductive material include carbon-based materials such as natural graphite, artificial graphite, carbon black, acetylene black, ketjen black, carbon fibers, and the like; metal-based materials of metal powder or metal fiber including copper, nickel, aluminum, silver; conductive polymers such as polyphenylene derivatives; or a mixture thereof.

In some embodiments, the negative electrode 112 and positive electrode 114 may be fabricated by a method including mixing an active material, a conductive material, and a binder into an active material composition and coating the composition on a current collector.

In some embodiments, the solvent can be N-methylpyrrolidone but it is not limited thereto.

In some embodiments, the separator 113 may be formed as a single layer or a multilayer, and may be made of polyethylene, polypropylene, polyvinylidene fluoride, or a combination thereof.

Hereinafter, examples of one or more embodiments will be described in more detail including comparative examples. However, these examples are not intended to limit the scope of the one or more embodiments.

In the following examples, if the detailed description of the already known structure and operation may confuse the subject matter of the present disclosure, the detailed description thereof will be omitted.

### Preparation of Electrolyte Solution

### Examples 1 to 12 and Comparative Examples 1 to 14

LiPF₆ having a concentration of 1.4 M was dissolved in a mixed solution of ethylene carbonate (EC), ethylmethyl carbonate (EMC), and dimethyl carbonate (DMC) in the amount shown in the following Table 1, and diphenyl carbonate (DPC) was added thereto in the amount shown in the following Table 1 to provide an electrolyte.

TABLE 1

| | | EC | EMC | DMC | DPC |
|---|---|---|---|---|---|
| | LiPF₆ | (volume | (volume | (volume | (parts by |
| | (M) | %) | %) | %) | weight*) |
| Example 1 | 1.4 | 20 | 20 | 60 | 1 |
| Example 2 | 1.4 | 30 | 20 | 50 | 1 |
| Example 3 | 1.4 | 20 | 20 | 60 | 2 |
| Example 4 | 1.4 | 30 | 20 | 50 | 2 |
| Example 5 | 1.4 | 20 | 20 | 60 | 3 |
| Example 6 | 1.4 | 40 | 20 | 40 | 3 |
| Example 7 | 1.4 | 20 | 20 | 60 | 5 |
| Example 8 | 1.4 | 30 | 20 | 50 | 5 |
| Example 9 | 1.4 | 20 | 20 | 60 | 7 |
| Example 10 | 1.4 | 30 | 20 | 50 | 7 |
| Example 11 | 1.4 | 20 | 20 | 60 | 10 |
| Example 12 | 1.4 | 30 | 20 | 50 | 10 |
| Comparative | 1.4 | 20 | 20 | 60 | 0 |
| Example 1 | | | | | |
| Comparative | 1.4 | 30 | 20 | 50 | 0 |
| Example 2 | | | | | |
| Comparative | 1.4 | 20 | 20 | 60 | 0.1 |
| Example 3 | | | | | |
| Comparative | 1.4 | 30 | 20 | 50 | 0.3 |
| Example 4 | | | | | |
| Comparative | 1.4 | 20 | 20 | 60 | 12 |
| Example 5 | | | | | |
| Comparative | 1.4 | 30 | 20 | 50 | 15 |
| Example 6 | | | | | |
| Comparative | 1.4 | 10 | 20 | 70 | 1 |
| Example 7 | | | | | |
| Comparative | 1.4 | 15 | 20 | 65 | 1 |
| Example 8 | | | | | |
| Comparative | 1.4 | 45 | 20 | 35 | 1 |
| Example 9 | | | | | |
| Comparative | 1.4 | 50 | 20 | 30 | 1 |
| Example 10 | | | | | |
| Comparative | 1.1 | 20 | 20 | 60 | 1 |
| Example 11 | | | | | |
| Comparative | 1.1 | 30 | 20 | 50 | 1 |
| Example 12 | | | | | |
| Comparative | 1.2 | 20 | 20 | 60 | 1 |
| Example 13 | | | | | |
| Comparative | 1.2 | 30 | 20 | 50 | 1 |
| Example 14 | | | | | |

part by weight*: content unit based on the total 100 parts by weight of EC, EMC and DMC.

### Fabrication of Rechargeable Lithium Battery Cells

A positive active material of LiCoO₂, a binder of polyvinylidene fluoride (PVDF), and a conductive material of carbon were mixed in a weight ratio of 92:4:4 and dispersed in N-methyl-2-pyrrolidone to provide a positive active material layer composition. The positive active material layer composition was coated on an aluminum foil having a thickness of 20 μm, dried, and compressed to provide a positive electrode.

A negative active material of artificial graphite and a binder of polyvinylidene fluoride (PVDF) were mixed in a weight ratio of 92:8 and dispersed in N-methyl-2-pyrrolidone to provide a negative active material layer composition. The negative active material layer composition was coated on a copper foil having a thickness of 15 μm, dried and compressed to provide a negative electrode.

The positive electrode and the negative electrode, and a polyethylene separator having a thickness of 25 μm were wound and compressed to provide a rechargeable lithium battery cell having a capacity of 2800 mAh. As an electrolyte, each electrolyte obtained from the Examples 1 to 12 and Comparative Examples 1 to 14 was used.

### Evaluation 1

### Evaluation of Low Temperature (5° C.) Cycle-Life Characteristic of Rechargeable Lithium Battery Cell

Each rechargeable lithium battery cell obtained from Example 1 to 12 and Comparative Example 1 to 14 was charged and discharged at 5° C. for 300 times to evaluate the cycle-life characteristic, and the results are shown in the following Table 2.

The charge and discharge were performed by charging the cell under the cut-off condition of 0.8C, 4.3V, 0.05C, allowing to stand for 10 minutes, and discharging under the condition of 0.5C, 3.0V and repeating these steps for 300 times.

TABLE 2

| | 5° C. cycle-life characteristic | |
|---|---|---|
| | Capacity at 35th cycle (mAh) | Capacity retention (%)* |
| Example 1 | 2196 | 78 |
| Example 2 | 1997 | 71 |
| Example 3 | 2138 | 76 |
| Example 4 | 1975 | 71 |
| Example 5 | 1930 | 70 |
| Example 6 | 1710 | 61 |
| Example 7 | 1842 | 66 |
| Example 8 | 1810 | 65 |
| Example 9 | 1790 | 64 |
| Example 10 | 1755 | 63 |
| Example 11 | 1702 | 61 |
| Example 12 | 1704 | 61 |
| Comparative | 1205 | 43 |
| Example 1 | | |
| Comparative | 1044 | 37 |
| Example 2 | | |
| Comparative | 1102 | 39 |
| Example 3 | | |
| Comparative | 1064 | 38 |
| Example 4 | | |
| Comparative | 586 | 21 |
| Example 5 | | |
| Comparative | 479 | 17 |
| Example 6 | | |
| Comparative | 534 | 19 |
| Example 7 | | |
| Comparative | 584 | 21 |
| Example 8 | | |
| Comparative | 340 | 12 |
| Example 9 | | |
| Comparative | 228 | 8 |
| Example 10 | | |
| Comparative | 207 | 7 |
| Example 11 | | |
| Comparative | 311 | 11 |
| Example 12 | | |
| Comparative | 348 | 12 |
| Example 13 | | |
| Comparative | 326 | 12 |
| Example 14 | | |

*capacity retention (%): percentage value of discharge capacity at 35th cycle to the initial discharge capacity (2800 mAh).

As shown in Table 2, Examples 1 to 12 confirm that lithium salt, ethylene carbonate, and diphenyl carbonate mixed in an appropriate range had excellent cycle-life characteristics at a high voltage and a low temperature compared to Comparative Examples 1 to 14.

For example, in Comparative Examples 1 and 2 including no diphenyl carbonate; Comparative Examples 3 to 6 including diphenyl carbonate out of an appropriate range; Comparative Examples 7 to 10 including ethylene carbonate out of an appropriate range; and Comparative Examples 11 to 14 including lithium salt out of an appropriate range, confirm that the low temperature cycle-life characteristics were deteriorated in a high voltage band.

While the present embodiments have been described in connection with what is presently considered to be practical exemplary embodiments, it is to be understood that the invention is not limited to the disclosed embodiments and is intended to cover various modifications and equivalent arrangements included within the spirit and scope of the appended claims.

What is claimed is:

1. An electrolyte for a rechargeable lithium battery comprising:
about 1.3 M to about 2.0 M of a lithium salt;
an organic solvent comprising an ethylene carbonate; and
an additive comprising a diphenyl carbonate;
wherein the ethylene carbonate is present in an amount of from about 20 volume % to about 40 volume % based on the total amount of the organic solvent, and
the diphenyl carbonate is present in an amount of from about 0.5 parts to about 10 parts by weight based on the total 100 parts by weight of the organic solvent.

2. The electrolyte for a rechargeable lithium battery of claim 1, wherein the ethylene carbonate is present in an amount of from about 20 volume % to about 35 volume % based on the total amount of the organic solvent.

3. The electrolyte for a rechargeable lithium battery of claim 1, wherein the diphenyl carbonate is present in an amount of from about 0.5 parts to about 5 parts by weight based on the total 100 parts by weight of the organic solvent.

4. The electrolyte for a rechargeable lithium battery of claim 1, wherein the organic solvent further comprises an ethylmethyl carbonate and a dimethyl carbonate.

5. The electrolyte for a rechargeable lithium battery of claim 4, wherein the ethylmethyl carbonate and the dimethyl carbonate are present in an amount of from about 10 volume % to about 60 volume % and about 20 volume % to about 70 volume %, respectively, based on the total amount of the organic solvent.

6. The electrolyte for a rechargeable lithium battery of claim 1, wherein the lithium salt comprises at least one of LiPF₆, LiBF₄, LiSbF₆, LiAsF₆, LiC₄F₉SO₃, LiClO₄, LiAlO₂, LiAlCl₄, LiN(SO₂CₓF₂ₓ₊₁)(SO₂C_{y}F_{2y+1}) (where x and y are natural numbers), LiCl, LiI, or a combination thereof.

7. A rechargeable lithium battery comprising:
a positive electrode;
a negative electrode; and
an electrolyte comprising an about 1.3 M to about 2.0 M of a lithium salt, an organic solvent comprising an ethylene carbonate, and an additive comprising a diphenyl carbonate,
wherein the ethylene carbonate is present in an amount of from about 20 volume % to about 40 volume % based on the total amount of the organic solvent,
the diphenyl carbonate is present in an amount of from about 0.5 parts to 10 parts by weight based on the total 100 parts by weight of the organic solvent.

8. The rechargeable lithium battery of claim 7, wherein the ethylene carbonate is present in an amount of from about 20 volume % to 35 volume % based on the total amount of the organic solvent.

9. The rechargeable lithium battery of claim 7, wherein the diphenyl carbonate is present in an amount of from about 0.5 parts to 5 parts by weight based on the total 100 parts by weight of the organic solvent.

10. The rechargeable lithium battery of claim 7, wherein the organic solvent further comprises an ethylmethyl carbonate and a dimethyl carbonate.

11. The rechargeable lithium battery of claim 10, wherein the ethylmethyl carbonate and the dimethyl carbonate are comprises in about 20 volume % to about 80 volume % and about 20 volume % to about 80 volume %, respectively, based on the total amount the organic solvent.

12. The rechargeable lithium battery of claim 7, wherein the rechargeable lithium battery has a charge voltage of about 4.3V or more.

13. The rechargeable lithium battery of claim 7, wherein the lithium salt comprises at least one of LiPF₆, LiBF₄, LiSbF₆, LiAsF₆, LiC₄F₉SO₃, LiClO₄, LiAlO₂, LiAlCl₄, LiN(SO₂CₓF₂ₓ₊₁)(SO₂C_{y}F_{2y+1}) (where x and y are natural numbers), LiCl, LiI, or a combination thereof.
